(19) United States
(12) Patent Application Publication
(10) Pub. No.: US 2024/0327184 A1
(43) Pub. Date: Oct. 3, 2024

(54) CONVEYANCE SYSTEM AND AUTOMATED GUIDED VEHICLE

(71) Applicant: LexxPluss, Inc., Kanagawa (JP)

(72) Inventors: Masaya ASO, Tokyo (JP); Alex TANAKA, Tokyo (JP); Leo HORSMAN, Tokyo (JP); Masashi KOYAMA, Tokyo (JP)

(21) Appl. No.: 18/704,920

(22) PCT Filed: May 16, 2022
(86) PCT No.: PCT/JP2022/020361

§ 371 Date: Apr. 26, 2024

(30) Foreign Application Priority Data
Nov. 8, 2021 (WO) PCT/JP2021/040998

(51) Int. Cl. B66F 9/075; B66F 9/06

(52) U.S. Cl. CPC B66F 9/0755; B66F 9/063

(57) ABSTRACT

A conveyance system comprises a conveyed object and an automated guided vehicle that conveys the conveyed object, wherein the automated guided vehicle includes a connecting part that detachably connects to a connected part provided on the conveyed object, a pair of electrodes that energize through connection between the connecting part and the connected part, an energized state detecting unit that acquires information on an energized state of an electric circuit provided with the pair of electrodes, and a judging unit that judges a connection state between the automated guided vehicle and the conveyed object based on the information on the energized state.

### TECHNICAL FIELD

The present disclosure relates to conveyance systems and automated guided vehicles.

### BACKGROUND ART

In recent years, there have been practically used automated guided vehicles for conveying cargos within facilities such as factories and warehouses. The automated guided vehicles travel to predetermined destination positions along a predetermined rail track laid in the facilities or autonomously using self-position estimation and environmental mapping techniques.

Patent Literature 1 discloses a method of conveying (towing) a cart or other object to be conveyed using an automated guided vehicle. In addition, Patent Literature 1 proposes a method of detecting an obstacle, a pushable bar being provided on the side of the cart while a sensor being provided in an automated guided vehicle, through the bar's striking of the sensor when the bar is pushed inward in response to contacting the obstacle.

### PRIOR ART LIST

### Patent Literature

Patent Literature 1: Japanese Unexamined Patent Publication No. 2011-102076

### SUMMARY OF THE INVENTION

### Technical Problem

However, the above method is not enough in safety when the automated guided vehicle conveys the conveyed object.

The present disclosure is made in view of the above problem, and the purpose thereof is to provide a conveyance system and an automated guided vehicle that can improve safety when the automated guided vehicle conveys the conveyed object.

### Technical Solution

According to the present disclosure, a conveyance system comprises a conveyed object and an automated guided vehicle that conveys the conveyed object, wherein the automated guided vehicle includes a connecting part that detachably connects to a connected part provided on the conveyed object, a pair of electrodes that energize through connection between the connecting part and the connected part, an energized state detecting unit that acquires information on an energized state of an electric circuit provided with the pair of electrodes, and a judging unit that judges a connection state between the automated guided vehicle and the conveyed object based on the information on the energized state.

According to the present disclosure, a conveyance system is provided, wherein the conveyed object includes a contact sensor that changes in the energized state through contact with an obstacle, the contact sensor electrically connects to the pair of electrodes through the connection between the connecting part and the connected part, the judging unit detects the contact with the obstacle based on information on the energized state with the connecting part and the connected part connecting to each other.

According to the present disclosure, a conveyance system is provided, wherein the connecting part has at least one rod member that advances and retracts axially toward the connected part that is concave.

According to the present disclosure, a conveyance system is provided, wherein the connecting part has at least two rod members that advance and retract axially toward the connected part that is concave, and the at least two rod members are respectively provided with one and the other of the pair of electrodes.

According to the present disclosure, a conveyance system is provided, wherein the connected part is laid under the bottom surface of the conveyed object.

According to the present disclosure, a conveyance system is provided, wherein the connected part has a first connected part to which the connecting part connects on connection of the automated guided vehicle to the conveyed object in a first posture, and a second connected part to which the connecting part connects on connection of the automated guided vehicle to the conveyed object in a second posture different from the first posture.

According to the present disclosure, a conveyance system is provided, wherein the automated guided vehicle includes another connecting part that serves as an axis of rotation by rotating the automated guided vehicle with the connecting part connecting to the connected part on changing of a posture of the automated guided vehicle from a connection state to the conveyed object.

According to the present disclosure, an automated guided vehicle conveying a conveyed object, comprises: a connecting part that detachably connects to a connected part provided on the conveyed object, a pair of electrodes that energizes through connection between the connecting part and the connected part, an energized state detecting unit that acquires information on an energized state of an electric circuit provided with the pair of electrodes, and a judging unit that judges a connection state between the automated guided vehicle and the conveyed object based on the information on the energized state.

### Advantageous Effects

According to the present disclosure, the conveyance system and the automated guided vehicle can enhance safety when the automated guided vehicle conveys the conveyed.

### BRIEF DESCRIPTION OF THE DRAWING

FIG. 1 is a perspective view showing an example of a connection between the automated guided vehicle and the cart in the conveyance system according to the embodiment.

FIG. 2 is a perspective view showing an example of the automated guided vehicle according to the embodiment.

FIG. 3 is a diagram showing an example of the connecting part and the connected part according to the embodiment.

FIG. 4 is a plan view showing the automated guided vehicle according to the embodiment.

FIG. 5 is a diagram showing an example of the electric circuit of the automated guided vehicle and the cart according to the embodiment.

FIG. 6 is a diagram showing an example of the connection posture of the automated guided vehicle and the cart according to the embodiment.

FIG. 7 is a diagram showing another example of the connection posture of the automated guided vehicle and the cart according to the embodiment.

FIG. 8 is a diagram showing further another example of the connection posture of the automated guided vehicle and the cart according to the embodiment.

FIG. 9 is a diagram showing another example of the cart according to the embodiment.

FIG. 10 is a diagram showing another example of the automated guided vehicle according to the embodiment.

FIG. 11 is a diagram showing further another example of the automated guided vehicle according to the embodiment.

FIG. 12 is a diagram showing another example of a connection between the automated guided vehicle and the cart in the conveyance system according to the embodiment.

FIG. 13 is a diagram showing the overall configuration of the conveyance system according to the embodiment.

FIG. 14 is a diagram showing an example of the functional configuration of the automated guided vehicle according to the embodiment.

FIG. 15 is a flowchart showing an example of a control flow that the automated guided vehicle connects to the conveyed object for conveying.

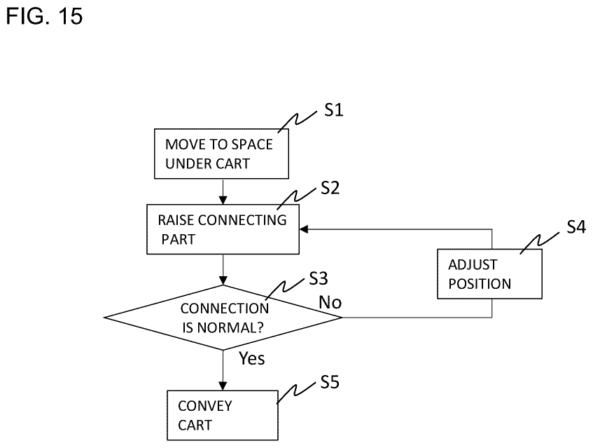

### DETAILED DESCRIPTION OF THE EMBODIMENTS

Hereinafter, the embodiment of the present disclosure will be described with reference to the drawings. Duplicated explanations in the specification and the drawings will be omitted on components having substantially identical functional configurations, by applying the same symbols thereto.

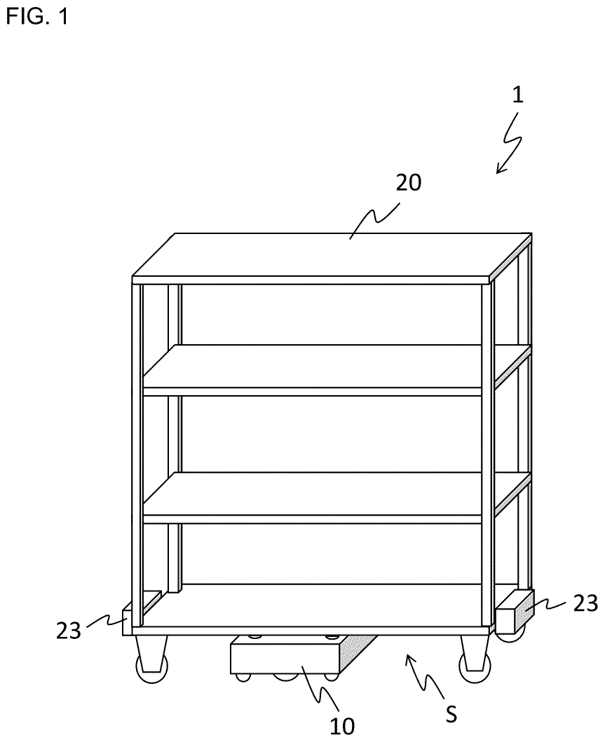

The conveyance system 1 shown in FIG. 1 includes an automated guided vehicle 10 and a cart 20, which is towed by automated guided vehicle 10. FIG. 1 shows an example that the automated guided vehicle 10 connects to the cart 20 with being laid under the cart 20.

The object to be conveyed, that is, the conveyed object may be, for example, the cart 20 shown in FIG. 1. The conveyed object is not limited to an object having wheels, such as the cart 20, but can also be, for example, a pallet, as long as it can be connected to and towed (conveyed) by the automated guided vehicle 10. When conveying objects such as pallets or cabinets having no wheels, the automated guided vehicle 10 may connect to the pallet or cabinet by moving thereunder to them.

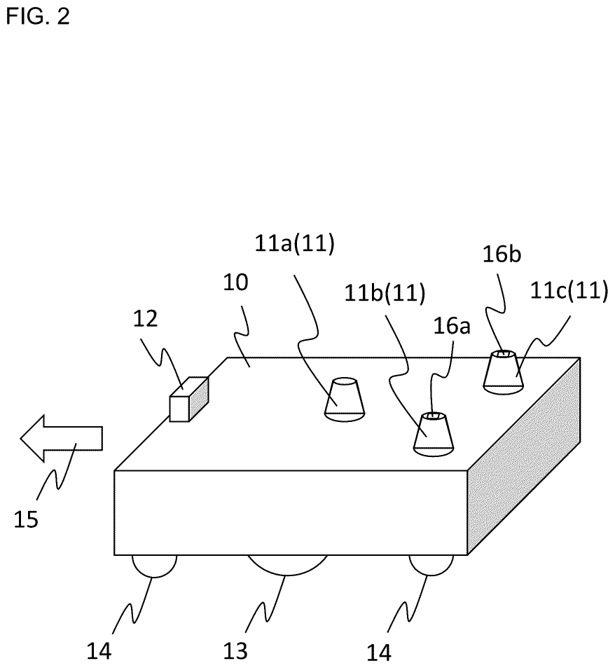

FIG. 2 is a perspective view of an example hardware configuration of the automated guided vehicle 10 according to the embodiment. The arrow 15 in FIG. 2 indicates the direction of travel (forward direction) of the automated guided vehicle 10. As shown in FIG. 2, the automated guided vehicle 10 is provided with a connecting part 11 for connecting to the cart 20. By driving the connecting part 11, the automated guided vehicle 10 can switch between a connection state and a disconnection state, where the automated guided vehicle 10 connects to the cart 20 in the former while disconnecting therefrom in the latter. The automated guided vehicle 10 is provided with an object position detecting unit 12 that detects objects around the guided vehicle, driven wheels 13, and non-driven wheels 14. The configuration of the automated guided vehicle 10 is not limited to the illustrated example and can be modified as needed. The automated guided vehicle 10 can move forward in the direction of arrow 15, backward in the opposite direction, and turn left and right. The automated guided vehicle 10 can operate autonomously based on a predetermined program stored in the storage unit, it can operate based on information given by recognizing track lines and track markers on the floor surface with sensors, it can operate based on user input via the input unit, or it can operate based on a combination thereof.

The connecting part 11 detachably connects (engages) to the connected part 21 provided on the cart 20. When the connecting part 11 connects to the connected part 21, the automated guided vehicle 10 connects to the cart 20. The automated guided vehicle 10 operates or travels in the connection state, whereby the cart 20 can be conveyed by following the motion of the automated guided vehicle 10.

The connecting part 11 is positioned on the top surface of the automated guided vehicle 10 and is provided in an upward direction. The connecting part 11 includes at least one rod member that moves axially forward and backward toward the concave connected part 21, for example, as shown in the figure. The rod member includes, for example, an actuator that advances and retracts in the axial direction. Each of the connecting parts 11 can operate independently and separately while all of the connecting parts 11 can advance and retract simultaneously. The connecting part 11 is configured as below: the rod member is extended vertically upward (advanced axially) to connect the connecting part 11 with the connected part 21 in the cart, while it is retracted (retreated axially) to disconnect the connecting part 11 from the connected part 21. The connecting part 11 is preferably housed in a space open to the top surface of the automated guided vehicle 10 not to protrude from the top surface in the disconnecting state. The rod member is preferably shaped to gradually taper toward the tip to facilitate entry into the connected part 21. The rod member is cylindrical as a whole and conical at the tip.

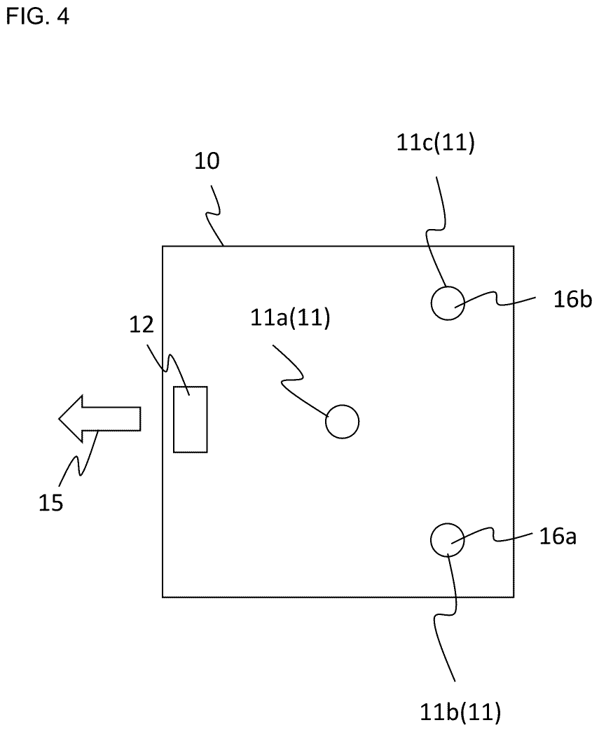

The connecting part 11 illustrated in FIGS. 2 and 4 includes three rod members. Specifically, the connecting part 11 includes a central connecting part 11a and a pair of rear connecting parts 11b and 11c, where the former is located in the center region of the automated guided vehicle 10 in plan view, and the latter is located behind the central connecting part 11a and on either side of the central connecting part 11a. On the cart 20 side are provided at least three connected parts 21. Greater number of rod members composing the connecting part 11 more strengthens the connection between the automated guided vehicle 10 and the cart 20.

The connecting part 11 is provided with at least a pair of electrodes 16a and 16b. The pair of electrodes 16a and 16b is energized in a state that the connecting part 11 is connecting to the connected part 21. The connecting part 11 is de-energized in a state when being disconnecting from the connected part 21. The pair of electrodes is made of conductive materials. The pair of electrodes includes a first electrode 16a and a second electrode 16b.

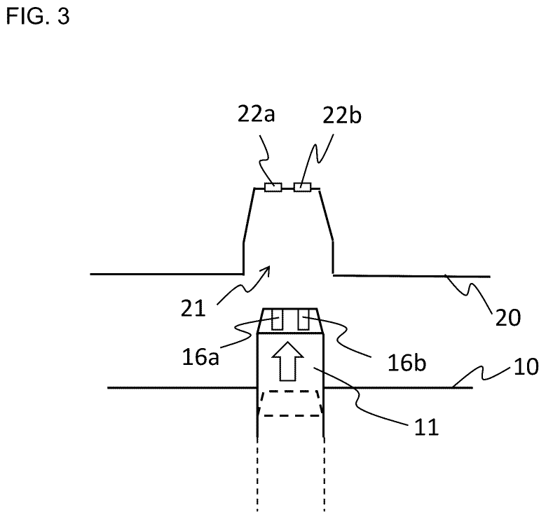

The pair of electrodes 16a and 16b may be provided on any one rod member as shown in FIG. 3, or may be separately provided on two rod members as shown in FIGS. 2 and 4. The pair of electrodes 16a and 16b is spaced apart from each other.

In FIGS. 2 and 4, the pair of electrodes 16a and 16b is separately provided in two rear connecting parts 11b and 11c. More specifically, for the pair of left and right rear connecting parts 11b and 11c, one electrode (first electrode) 16a is provided in the left rear connecting part 11b (assuming the arrow 15 indicates forward) and the other electrode (second electrode) 16b is provided in the right rear connecting part 11c. When one electrode is provided on one rod member, the entire of the rod member or the entire tip thereof may be the electrode. Thus, the area of one electrode provided on one rod member can be larger than the areas of two (a pair of) electrodes provided on one rod member. Accordingly, the contact area of the electrode becomes larger, thereby increasing the reliability of the electrical connection. The pair of electrodes may be provided in each of the plural connecting parts 11 (see FIG. 3), thus to enable checking whether all of the connecting parts 11 are being normally connecting with the connected parts 21.

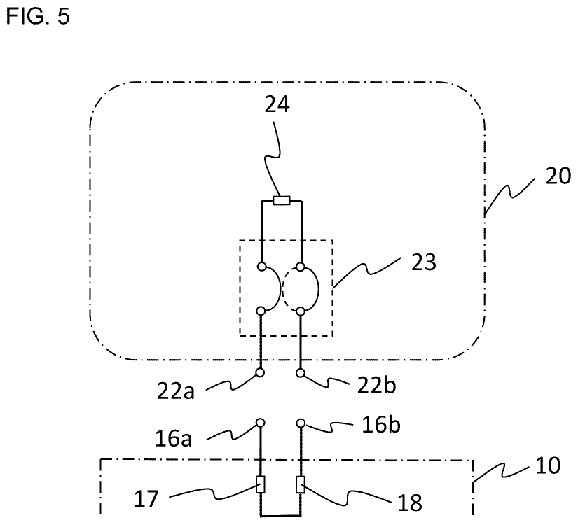

As shown in FIG. 5, the pair of electrodes 16a and 16b are connected to a power supply 17 and an electric sensor 18 (energized state detecting unit) provided on the automated guided vehicle 10. The electric sensor is not limited to, for example, a sensor that measures current, voltage, and resistance. The electric sensor 18 can acquire information on the energized state of an electric circuit. The electric sensor 18 can detect whether the electric circuit, which includes at least a pair of electrodes 16a and 16b, is energized. The electric sensor is preferably capable of detecting the numerical value and magnitude of current, voltage, and resistance in the electric circuit including the pair of electrodes 16a and 16b.

The pair of electrodes 16a and 16b is de-energized when the automated guided vehicle 10 and the cart 20 do not properly connect to each other, to be energized otherwise. Using electric sensors to acquire information on the energized state of the electric circuit including the pair of electrodes units 16a and 16b enables judging whether or not the connection is properly established. In summary, the judging unit in the control unit judges that the electric circuit including the pair of electrodes 16a and 16b is normally connected when the electric circuit is energized, and not normally connected otherwise. If the connection is judged not to be normally established, the connecting part 11 may be moved backward to readjust the position of the automated guided vehicle 10 and connected to the connected part again. The judging unit may be in the control unit of the automated guided vehicle 10 or in the control unit of an information processing device such as a server connected via a network.

In the connected part 21 of the cart 20 are provided conductive parts corresponding to the pair of electrodes 16a and 16b of the automated guided vehicle 10. The conductive parts contact and energize the pair of electrodes 16a and 16b.

As shown in FIG. 3, on one connecting part 11 is provided the pair of electrodes 16a and 16b, while on at least one connected part 21 is provided the conductive part, which energizes the pair of electrodes 16a and 16b. With the cart 20 being provided with plural connected parts 21, all of the connected parts 21 may be provided with the conductive parts, or only some of the connected parts 21 may be provided with the conductive parts.

In FIG. 3, the pair of electrodes 22a and 22b composing the conductive parts is provided in one connected part 21 on the cart 20, and contacts the pair of electrodes 16a and 16b on the automated guided vehicle 10, respectively. In the connected part 21, the pair of electrodes 22a and 22b is arranged apart from each other, and electrically connected via conductive materials such as an electric wire.

As shown schematically in FIG. 5, to the pair of electrodes 22a and 22b in the cart 20 is electrically connected an electric resistor 24 via the contact sensor 23. The contact sensor 23 and the electric resistor 24 are not essential, and only one thereof may be connected. The contact sensor 23 is positioned on the outer surface of the cart 20 to detect a contact of an obstacle with the cart 20. The configuration of the contact sensor 23 is not limited.

The contact sensor 23 is, for example, a tape switch. The tape switch includes electrode plates arranged with a slight gap therebetween and covered with a resin such as rubber, and the entire tape switch is formed as tape-shaped. When an obstacle or other object comes into contact with the tape switch, the gap between the electrode plates disappears (the electrode plates make contact with each other), which causes an electric current to flow between the electrode plates, thus to enable detecting the above contact. The contact sensors 23 may be of other types. The contact sensors 23 can be arranged at the four corners of the cart 20, that is, in the front, rear, left, and right sides, and in short, along the entire circumference of the cart 20. One long contact sensor 23 may be arranged as ring-shaped around the outer circumference of the cart 20, or two or more relatively small contact sensors 23 may be arranged separately at plural locations, such as the front, rear, and both right and left sides. The plural contact sensors 23 may be arranged at separate positions on the cart 20 (front, rear, and both right and left sides), and also electric circuits may be separately configured for each of the contact sensors 23 to check their respective energized states. This enables checking which part of the cart 20 has come into contact with an obstacle or the like. The contact sensors 23 may be provided at any height, such as at the lower and upper ends of the cart 20 and at the center therebetween. The contact sensors 23, being arranged at the lower end of the cart 20, more easily detects contact with an obstacle at a low position near the floor, while the contact sensors 23, being arranged at the upper end of the cart 20, more easily detects contact with an obstacle at a high position (for example, an object suspended from the ceiling).

In FIG. 5, the connecting part 11 on the automated guided vehicle 10 enters and joins the connected part 21 on the cart 20, which establishes a normal connection state between the automated guided vehicle 10 and the cart 20, whereby the pair of electrodes 16a and 16b on the automated guided vehicle 10 contact the pair of electrodes 22a and 22b on the cart 20, respectively. The above contacts between the electrodes (between the electrodes 16a and 22a, and between the electrodes 16b and 22b) form the electric circuit between the automated guided vehicle 10 and the cart 20, thus energizing.

Herein, the electric resistor 24 is connected via the tape switch in the cart 20, and the current (or voltage) is relatively small due to the electric resistor 24 when there is no contact with an obstacle (non-collision), and relatively large when there is contact therewith (collision) because electricity flows between the electrodes of the tape switch without going through the electric resistor 24. Detecting such a change in the energized state by the energized state detecting unit (electric sensor 18) enables detecting (judging) whether or not the cart 20 has contacted an obstacle or other object.

Accordingly, despite the configuration of the embodiment being simple, the configuration easily makes it possible to both judge whether or not the automated guided vehicle 10 is normally connected to the cart 2 (towing availability judgment) and judge whether or not an obstacle contacts the cart 20.

Herein, the cart 20 has a lower space S in which the automated guided vehicle 10 can be laid, for example, as shown in FIG. 1. On the underside of the cart 20 is provided a connected part 21. The connected part 21 preferably has a gradually increasing opening diameter downward from the viewpoint of facilitating entry of the connecting part 11. This configuration produces a guide surface that slides the connecting part 11 on the connected part 21 to guide the connecting part 11 theretoward. The connected part 21 can be, for example, conical (mortar-shaped). On the top or side surface of the connected part 21 is provided conductive parts such as electrodes 22a and 22b, depending on the positions of the electrodes arranged on the connecting part 11.

The above connected part 21 is located on the underside of the cart 20; however, it may be located on the side of the conveyed object, corresponding to the location of the connecting part 11 on the automated guided vehicle 10.

In the conveyance system 1 according to the embodiment, the connection posture of the automated guided vehicle 10 with the cart 20 is not limited to one pattern. Specifically, the automated guided vehicle 10 can be connected with the cart 20 in plural connection postures. With this configuration, the connection posture of the automated guided vehicle 10 to the cart 20 can be changed (adjusted) according to the direction in which the cart 20 is conveyed and the center of gravity position of the cart 20. The center of gravity position of the cart 20 varies according to the arrangement of the cargos loaded on the cart 20.

The connected part 21 may include a first connected part 21a and a second connected part 21b, where the former is connected by the connecting part 11 when the automated guided vehicle 10 connects to the conveyed object in a first posture, and the latter is connected by the connecting part 11 when the automated guided vehicle 10 connects thereto in a second posture different from the first posture. The first and second connected parts 21a and 21b may partially overlap.

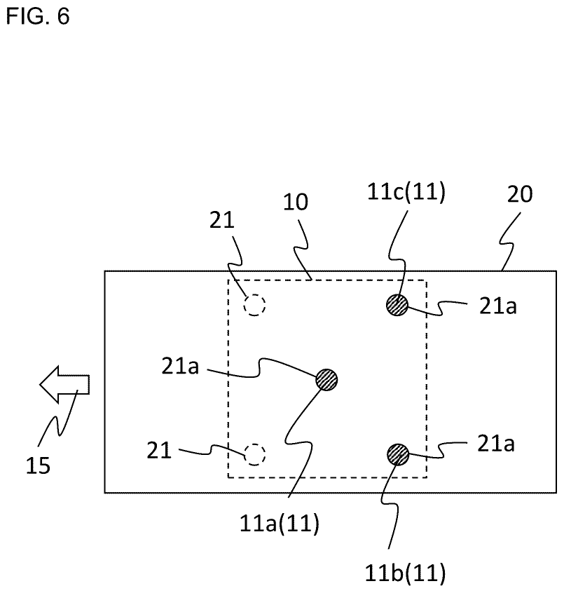

For example, as shown in FIG. 6, when moving in the longitudinal direction in plan view, the rectangular cart 20 is connected in a posture (posture 1) such that the front direction of the automated guided vehicle 10 (the direction indicated by the arrow 15) agrees with the direction in which the cart moves (left direction in FIG. 6).

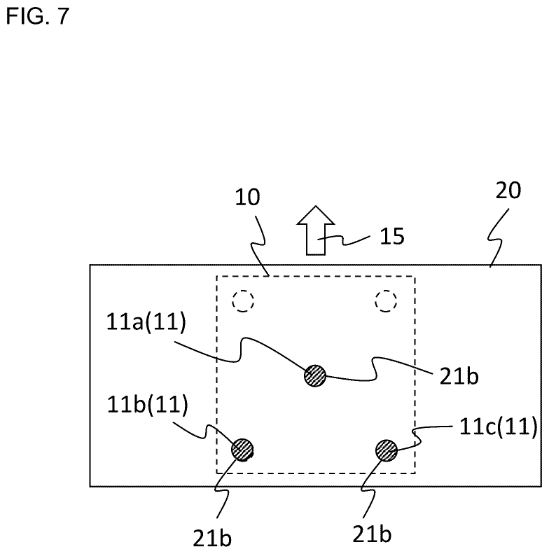

On contrast, as shown in FIG. 7, when moving in the lateral direction in plan view, the rectangular cart 20 is connected in another posture (second posture) such that the front direction of the automated guided vehicle 10 (the direction indicated by the arrow 15) agrees with the direction in which the cart moves (upward in FIG. 7).

As shown in FIGS. 6 and 7, the cart 20 is provided with a first connected part 21a that connects to the connecting part 11 when connecting in the first posture and a second connected part 21b that connects to the connecting part 11 when connecting in the second posture. The connected part 21 in the lower right in the figure acts as both the first and second connected parts 21a and 21b. The cart 20 has a central connected part 21 and four connected parts 21, where the former is located in the center of the cart 20 and connects the central connecting part 11a in the automated guided vehicle 10, and the latter are equally arranged around the central connected part 21 and connects the rear connecting parts 11b and 11c in the automated guided vehicle 10. The four connected parts 21 are arranged with the central connected part 21 being as their center and with an equal distance being laid between adjacent connected parts 21. In short, the four connected part 21 are located at the four corners of an imaginary square.

In FIGS. 6 and 7, changing to connection with the cart 20 in the second posture from connection therewith in the first posture (in summary, the orientation of the automated guided vehicle 10 with respect to the cart 20 changes by 90°), the automated guided vehicle 10 can change in posture with the central connecting part 11a being connected to the central connected part 21. In other words, with the central connecting part 11a being connected to the center connected part 21 in the first posture shown in FIG. 6, the connection between the two rear connecting parts 11b, 11c and the first connected part 21a can be released to rotate the automated guided vehicle 10 90 degrees, thereby to enable connecting the two rear connecting parts 11b, 11c to the second connected part 21b. Thus, the central connecting part 11a and the central connected part 21 can serve as a rotation axis for changing the posture of the automated guided vehicle 10. As the above rotation axis are available the connecting and connected parts other than the central connecting part 11a and the central connected part 21.

Thus, changing the posture of the automated guided vehicle 10 with respect to the cart 20 with one of the plural connecting parts 11 being connected to the connected part, which acts as the rotation axis, enables facilitating alignment between the connecting parts and the connected parts in changing of the above posture, thus to enable smooth connecting of the automated guided vehicle 10 to the cart 20. In changing of the posture of the automated guided vehicle 10, the connections may be released between all the connecting parts 11 and the connected parts 21.

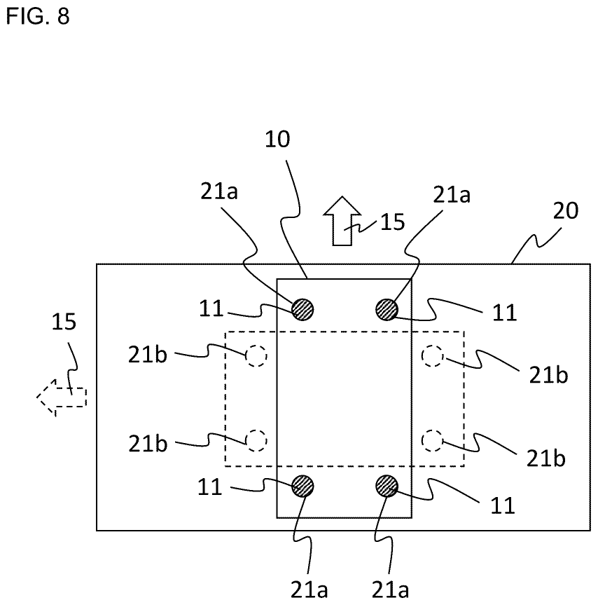

FIG. 8 illustratively shows that the four connecting parts 11 on the automated guided vehicle 10 are arranged in the corners of an imaginary rectangle in plan view. The space in the front-back direction between the connecting parts 11 adjacent to each other is larger than the space in the left-right direction between the connecting parts 11 adjacent to each other. The cart 20 is provided with four first connected parts 21a and four second connected part 21b, where the former connects to connecting parts 11 when the automated guided vehicle 10 connects in the first posture, while the latter connects thereto when the automated guided vehicle 10 connects in the second posture. The first and second connected parts 21a, 21b are provided at positions different from each other not to overlap. In FIG. 8, connecting and connected parts may be available that serve as the rotation axis in changing of the posture. The number and arrangement of the connected parts 21 on the cart 20 can be changed according to the number and arrangement of the connecting parts 11.

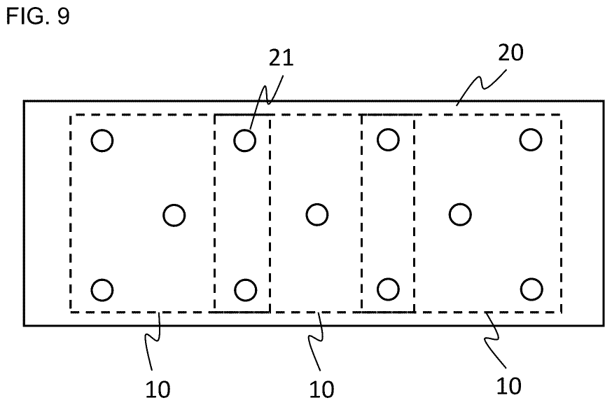

In FIG. 9, at the left (one side of the longitudinal direction), center, and right (other side thereof) of the cart 20 are provided plural connected parts 21, thus to allow the automated guided vehicle 10 to connect to the cart 20. The automated guided vehicle 10 with respect to the cart 20 can change in orientation freely according to the direction in which the cart 20 is conveyed. In FIG. 9, the automated guided vehicle 10 can connect to the cart 20 so that the front side of the automated guided vehicle 10 faces the four directions shown in the figure: upward, downward, left, and right. The posture of the automated guided vehicle 10 with respect to the cart 20 does not have to be at 90 degree intervals, but can be slanted or oblique. All of the connected parts 21 may be identical with each other in shape, or some thereof may be different from each other in shape corresponding to the shapes of the connecting parts 11.

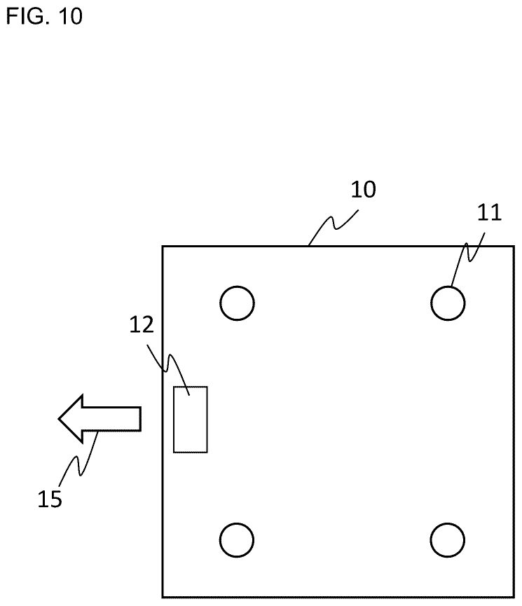

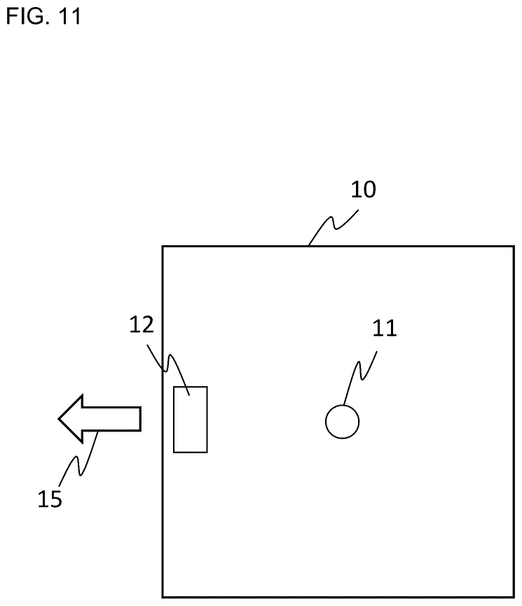

The number, location, operation, and shape of the connecting parts 11 on the automated guided vehicle 10 are not limited to the above examples and can be changed as needed. For example, the number of the connecting parts 11 may be at least one (1), and may be more or less than illustrated. Specifically, as shown in FIG. 10, four connecting parts 11 are available, while as shown in FIG. 11, only one connecting part is available. The location of the connecting parts 11 is not limited to the top surface of the automated guided vehicle 10; it may also be the front, rear, right and left sides. The movement of the connecting parts 11 may be not limited to axial advancement and retraction; it may also be pivoting around the axis to connect with the connected parts.

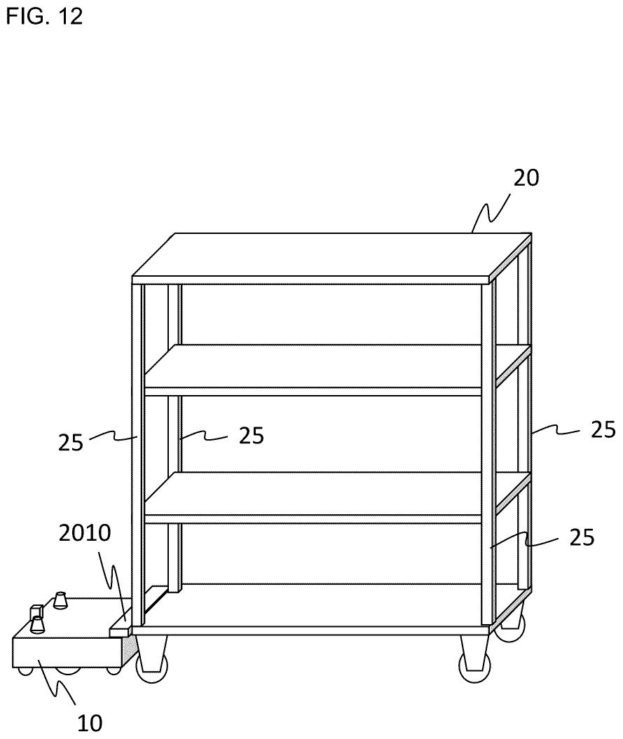

FIG. 12 shows another example of the hardware configuration when the automated guided vehicle 10 connects to the cart 20. In FIG. 12, the automated guided vehicle 10 connects to the cart 20 horizontally next thereto, without being laid under the cart 20. The cart 20 has a connected part 21 that at least partially connects to the connecting part 11, where the automated guided vehicle can connect to the cart 20 through extending of the connecting part 11 upward, and can disconnect therefrom through retracting thereof.

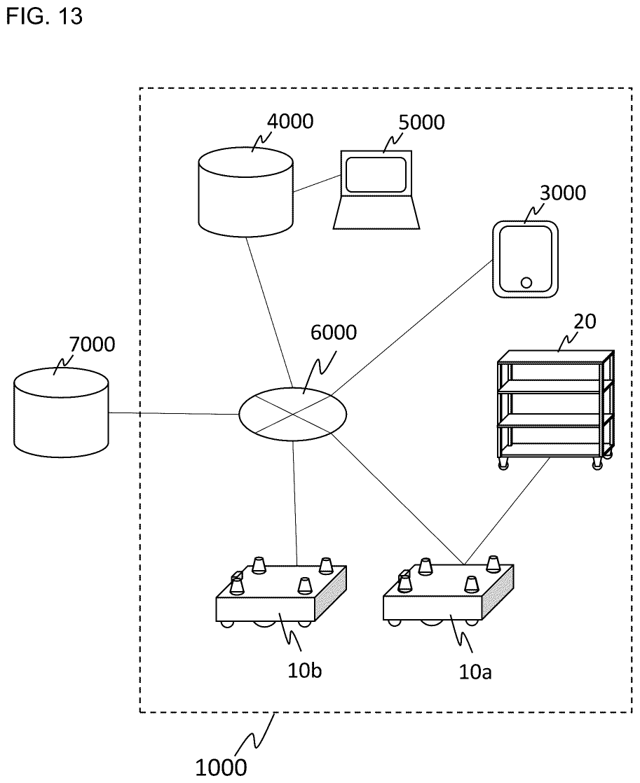

Hereinafter, the overall configuration of the conveyance system according to the embodiment will be described. FIG. 13 shows an example of the overall configuration of the conveyance system. The conveyance system 1000 includes plural automated guided vehicles (10a, 10b), a cart 20 to be conveyed, a control device 3000 that can display the state of the automated guided vehicles and act for inputting commands to the automated guided vehicles, an operation controlling device 4000 that manages information necessary for the operation of the automated guided vehicles, an I/O device 5000 that displays information from the operation control device and act for inputting information to the operation control device, and a communication network 6000 that communicatively connects the plural automated guided vehicles (10a, 10b), the control device 3000, and the operation controlling device 4000. For example, if information on the operational progress of manufacturing operations is given from a manufacturing management system, the conveyance amount and the conveyance routes of the automated guided vehicles can be dynamically adjusted according to the above operational progress of manufacturing operations.

The conveyance system 1000 can also connect to an external system 7000 via the communication network 6000. The conveyance system 1000, which is installed in a manufacturing plant to convey parts required for manufacturing from storage to a manufacturing line, is linked to the manufacturing management system as the external system 7000. When information on the operational progress of the manufacturing operation is given from the manufacturing management system, the conveyance amount and the conveyance routes of the automated guided vehicles can be dynamically adjusted according to the operational progress of the manufacturing operations. Each of the automated guided vehicles 10 is communicatively connected to the other automated guided vehicle and other components via the communication network 6000. For example, the automated guided vehicle transmits various detection information detected by its own detecting unit and other control information to the control device 3000, the operation controlling device 4000, and the other automated guided vehicle. In addition, the automated guided vehicle 10 communicatively connects to the cart 20 by using short-range communication means, thereby receiving from the cart information on connection state of the cart and identification information thereof.

The control device 3000 has the function of displaying status information on the designated automated guided vehicle and the function of inputting commands thereto. The status information on the automated guided vehicle displayed on the control device includes, for example, information on the charge level of the battery that is provided in the automated guided vehicle to serve as the power source therefor, and identification information on the cart connected to the automated guided vehicle. Commands fed to the automated guided vehicle include, for example, command information on the destination of the automated guided vehicle, commands for connecting or disconnecting the automated guided vehicle to/from the cart, commands for starting of the automated guided vehicle, and commands for stopping thereof.

The operation controlling device 4000 has a status information recording unit 4010 and an operation scenario managing unit 4020, where the former records status information of the plural automated guided vehicles operating in a facility area, and the latter manages operation scenarios for the plural automated guided vehicles. The state information on the automated guided vehicles recorded in the status information recording unit 4010 includes, for example, battery charge information of the plural automated guided vehicles in operation, identification information on the carts connected to the multiple automated guided vehicles, location information on the plural automated guided vehicles, operation mode of the plural automated guided vehicles (guided travel mode or autonomous travel mode), and other various detection information detected by the detecting unit 230 in the automated guided vehicles. The operation scenarios managed by the operation scenario managing unit 4020 include, for example, information on the destination of each of the plural automated guided vehicles, the contents of plural operations to be performed until reaching the destination, the operation sequence of the plural operations, and the switching conditions of the plural operations.

The I/O device 5000 can display information recorded in the status information recording unit 4010 in the operation controlling device 4000, and can add or update new operation scenarios by inputting operation scenarios managed by the operation scenario managing unit 4020. The information fed to the I/O device 5000 includes, for example, the destination of any automated guided vehicle, the contents of the operations for reaching the destination, and the operation switching conditions.

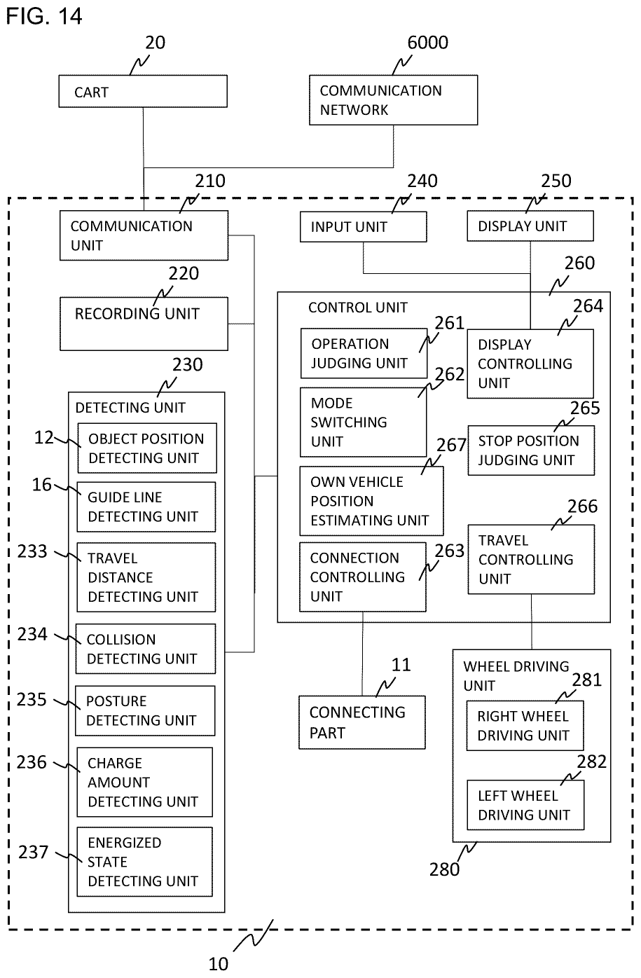

Next, the functions of the automated guided vehicle will be explained with reference to FIG. 14. FIG. 14 is a functional configuration diagram of the automated guided vehicle according to the embodiment. The automated guided vehicle 10 has a communication unit 210 that communicates with a cart 20 outside the automated guided vehicle and the communication network 6000, a recording unit 220, a detecting unit 230 provided with various sensors described below, a connecting part 11 for connecting with the cart, a wheel driving unit 280 that drives the wheels, an input unit 240, a display unit 250, and a control unit 260 that controls the operation of the wheel driving unit 280.

The recording unit 220 has the function of recording information received by the communication unit 210 from the outside, detection information detected by the detecting unit 230, and control information output by the control unit.

The detecting unit 230 has an object position detecting unit 12, a guide line detecting unit 232, a travel distance detecting unit 233, a collision detecting unit 234, a posture detecting unit 235, a charge amount detecting unit 236, and an energized state detecting unit 237. The object position detecting unit 12 includes a laser distance sensor (for example, LiDAR (light detection and ranging)) that measures the distance and direction to an object by emitting a laser beam and measuring the time taken to hit the object and return therefrom, a millimeter wave radar that detects the distance to an object based on the millimeter wave transmission signal and the received signal reflected back from the object, or a camera-type distance sensor that measures the distance to an object by capturing the object with a camera and analyzing the captured image.

For the guide line detecting unit 16 are used sensors according to the types of the above induction methods. As the induction method, for the electromagnetic induction method is used a pickup coil, for the magnetic induction method is used a magnetic sensor, and for the image recognition method is used a camera, which serve as sensors in the guide line detecting unit. The guide line detecting unit detects the guide line when being located directly above the guide line to output a detection signal. In addition to the detection signal of the guide line, the image recognition method, using a camera to read the guide line by using a two-dimensional code or bar code, prepares position information based on the information of the detected code, and relative angle information between the guide line and the automated guided vehicle by processing image information of the code.

The travel distance detecting unit 233 detects the number of rotations of the non-driven wheel 14 or the driven wheel 13 and measures the travel distance of the automated guided vehicle based on the detected information of the number of rotations and the diameter (or circumference length) of the non-driven wheel or the driven wheel. Alternatively, the travel distance detecting unit may detect the travel speed of the automated guided vehicle using a millimeter wave sensor that irradiates millimeter waves to the floor surface and detects the reflected waves, and estimate the travel distance by integrating the travel speed.

The collision detecting unit 234 has the function of detecting that the automated guided vehicle has collided with an obstacle or a person. Specifically, it includes the above contact sensor 23. It may detect acceleration with a gyro sensor or the like, and it may judge that there has occurred a collision when detecting a sudden change in acceleration. It may be provided with other bumpers or physical switches, and it may judge that there has occurred a collision when the physical switches are pressed. When detecting a collision, the collision detecting unit 234 stops the automated guided vehicle, records at least one of the information on the occurrence of the collision and the location of the collision into the recording unit, and notifies the information to the operation controlling device 4000 and the control device 3000. The posture detecting unit 235 detects the orientation (posture) of the own automated guided vehicle based on the magnetic compass or information on the number of rotations of the left and right drive wheels or steering information of the wheels.

The charge amount detecting unit 236 detects the charge amount of the battery, which is the power source of the automated guided vehicle. When detecting that the amount of charge detected falls below a predetermined value, the charge amount detecting unit 236 judges that charging is necessary, records the detection information of the decrease in charge amount into the recording unit, and notifies the information to the operation controlling device 4000 and the control device 3000. Furthermore, when detecting that the amount of charge falls below the predetermined value, the automated guided vehicle may automatically move to a recharging spot to recharge, in addition to the above process. The above predetermined value that the charge amount detecting unit 236 judges necessity of charging may be defined based on at least one of the distance to the destination set for the automated guided vehicle and the weight of the conveyed object connected thereto.

The energized state detecting unit 237 acquires information on the energized state of the electric circuit including the pair of electrodes in the connecting part 11 of the automated guided vehicle.

The input unit 240 includes physical switches or a touch panel provided in the automated guided vehicle, allowing the user to directly input operation commands into the automated guided vehicle. The display unit 250 includes a liquid crystal panel or the like provided in the automated guided vehicle, and displays state information on the automated guided vehicle (for example, various detection information by the detecting unit 230 and the currently executed operation scenario.)

The control unit 260 has an operation judging unit 261, a mode switching unit 262, a connection controlling unit 263, a display controlling unit 264, a stop position judging unit 265, a travel controlling unit 266, and an own vehicle position estimating unit 267. The operation judging unit 261 judges the operation of the automated guided vehicle based on the operation scenario of the own automated guided vehicle acquired from the operation scenario managing unit 4020. The operation judging unit 261 (judging unit) judges the connection state of the automated guided vehicle 10 to the conveyed object based on information on the energized state of the electric circuit including the pair of electrodes in the connecting part. In short, it judges whether or not the automated guided vehicle is normally connected. The conveyed object is judged to be able to be conveyed If the automated guided vehicle is connected normally, and is not otherwise. In summary, the operation judging unit 261 can judge whether or not conveyance is possible. The operation judging unit 261 can also detect contact with an obstacle based on information from the collision detecting unit 234 and judge whether or not to execute predetermined operations such as an emergency stop.

The mode switching unit 262 switches the travel mode of the automated guided vehicle between the guided travel mode and the autonomous travel mode based on the conditions preset in the operation scenario or the commands entered at the input unit 240. The connection controlling unit 263 controls the operation of the connecting part 11 to connect or disconnect to/from a cart or other conveyed objects based on the conditions preset in the operation scenario or the commands entered at the input unit 240. The display controlling unit 264 controls the above input unit 240 and display unit 250.

The stop position judging unit 265 judges the stop position of the own automated guided vehicle based on the position information of an object detected by the object position detecting unit 12 when the own automated guided vehicle arrives at a position preset for implementing the stop position judgment.

The travel controlling unit 266 controls the travel of the automated guided vehicle based on at least one of the judgment information by the operation judging unit 261, the mode switching unit 262, and the stop position judging unit 265. Specifically, it individually controls the right and left wheel driving units 281, 282 of the wheel driving unit 280. The right wheel driving unit 281 and left wheel driving unit 282 are composed of motors, for example, where controlling the rotation speed and direction of each drive wheel individually permits the automated guided vehicle to travel in a curve at any trail radius and rotate to change direction. The own vehicle position estimating unit 267 estimates the position of the own automated guided vehicle in the entire travel area based on the travel distance detected by the travel distance detecting unit 233, information on the direction of the own vehicle detected by the posture detecting unit 235, and map information of the entire area recorded in the recording unit 220. Alternatively, it may estimate the position of the own automated guided vehicle in the entire travel area based on the information on the distance and direction to the object measured by the object position detecting unit 12 and the map information of the entire area recorded in the recording unit 220. Alternatively, when the automated guided vehicle is traveling along the guide line composed of two-dimensional codes, it may estimate the position of the automated guided vehicle in the entire travel area based on the identification information of the two-dimensional codes and the above map information.

Next, the control flow of conveying the cart 20 connected to the automated guided vehicle 10 will be described with reference to FIG. 14. First, the automated guided vehicle 10 moves to the lower space S of the cart 20 (S1). Next, the connecting part 11 is raised toward the connected part 21 on the cart 20 (S2). Next, based on the information from the electric sensor, the connecting part 11 is judged whether or not to be normally connected to the connected part 21 (S3). If normal connection is not established (judged No in S3), the connecting part 11 is moved back once to adjust the position of the automated guided vehicle 10 (S4). Otherwise (judged Yes in S3), the automated guided vehicle 10 travels to convey the cart 20 (S5).

Thus, checking the connection status of the automated guided vehicle to the conveyed object, enables easy judging of whether or not the automated guided vehicle can tow and enhancing of the safety of the conveyance operation.

In disconnection of the automated guided vehicle 10 from the cart 20, checking the energized state enables checking whether the connection of the connecting part 11 to the connected part 21 has been properly disconnected.

As described above, the conveyance system 1 according to the embodiment includes the conveyed object (cart 20) and the automated guided vehicle 10 that conveys the conveyed object, and the automated guided vehicle 10 has the connecting part 11, the pair of electrodes 16a, 16b, the energized state detecting unit, and the judging unit, where the connecting part 11 is detachably connected to the connected part 21 provided on the conveyed object, the pair of electrodes 16a, 16b energizes in response to the connection of the connecting part 11 to the connected part 21, the energized state detecting unit acquires information on the energized state of the electric circuit including the pair of electrodes 16a, 16b, the judging unit judges the connection state of the automated guided vehicle to the conveyed object based on the information on the energized state. With this configuration, checking can be done whether or not the automated guided vehicle is properly connected to the conveyed object, through checking of the connection between the connecting part on the automated guided vehicle and the connected part on the conveyed object based on the energized state. This enables easy judging of whether or not the automated guided vehicle can tow, and enhancing of the safety of the conveyance operation.

The conveyed object (cart 20) has the contact sensor 23, energized state of which changing upon contact with an obstacle, where the contact sensor 23 is electrically connected to the pair of electrodes 16a, 16b when the connecting part 11 connects to the connected part 21, while the judging unit can detect contact with the obstacle based on information on the energized state of the connecting part 11 being connected to the connected part 21. This configuration, being simple, enables both judgment of whether or not towing is possible and the judgment of contact with an obstacle.

As described above, the connecting and connected parts 11, 21 are not limited to the above examples in shape and can be changed as needed therein. For example, as the connected part may be used the pillar 25 (see FIG. 12) of the cart 20, while as the connecting part may be used a hook-shaped or rope-shaped engaging unit that engages (hooks) the pillar 25. To one pillar (connected part) may be engaged one or more connecting parts, or to plural pillars may be each engaged a connecting part. The pillar 25 is at least partially made of energizable materials, energizing the pair of electrodes on the connecting part. There may be available one, two or more hook-shaped or rope-shaped engaging units, while the pair of electrodes may be provided in one engaging unit, and separately provided in engaging units, respectively.

The flat bottom of the cart 20 may be used as the connected part, and a supporting unit, supporting the bottom from below to lift it upward, may be used as the connecting part. This is effective, for example, when the automated guided vehicle 10 is laid under the cart 20, and the supporting unit of the automated guided vehicle 10 lifts and tows a part (front side, rear side, one side on either side.) or the whole of the cart 20. The flat bottom surface of the cart 20 is at least partially made of energizable materials, and the pair of electrodes is energized that is provided on the connecting part that contacts the energizable portion. The supporting unit may be a rod-like structure provided with an actuator that rises and falls.

As described above, the conveyance system according to the embodiment may have the function to notify the user of various types of information. For example, information on the connection status of the cart and the automated guided vehicle, and information on contact (collision) with obstacles may be notified from the automated guided vehicle 10 (or the cart) to at least one of the operation controlling device 4000 and the control device 3000. Specifically, when the automated guided vehicle is detected not to be properly connected to the cart, a notification is made to at least one of the operation controlling device 4000 and the control device 3000, which allows the user to check the connection status or manually reconnect, thereby to enhance safety. Another notification may also be made to the user, that indicates detection that the automated guided vehicle is being properly connected to the cart. The above notification on the connection status may be made either before the start of conveyance or during the conveyance. Before the start of the conveyance, the user can confirm whether or not the conveyance can start safely, while during the conveyance, the user can be notified of occurrence of disconnection between the cart and the automated guided vehicle. When contact with an obstacle is detected, a notification is made to at least one of the operation controlling device 4000 and the control device 3000, which enables instructing of the emergency stop of the automated guided vehicle 10 from the control device 3000, and checking of an impact (damage, misalignment, for example) on the automated guided vehicle 10, the cart 20, and the cargo. In addition, when a collision with an obstacle is detected, both collision information and connection status information can be notified, which enables checking whether or not the connection between the cart and the automated guided vehicle has been broken due to the collision.

The automated guided vehicle may also perform predetermined operations when the connection state between the cart and the automated guided vehicle meets predetermined conditions. The above predetermined conditions may be below, for example: the connection is broken (released) during conveyance of the cart, or the connection state is judged not to be normal at the start of conveyance or at a predetermined point in time therebefore. The above predetermined operations may be below, for example: emergency stop, stop of travel, raising or lowering of the connecting part (rod member, for example). Accordingly, for example, if the connection between the cart and the automated guided vehicle is broken during travel to cause an emergency stop, or if the connection is insufficient (abnormal) at the start of the conveyance, raising the connecting part can establish the connection, or lowering it can check the connection once. The automated guided vehicle may also implement the predetermined operations when the predetermined conditions are met that is related to contact (collision) with an obstacle. For example, if contact with an obstacle is detected during conveyance of the cart, the automated guided vehicle may make an emergency stop or retreat a predetermined distance to stop or turn. The above conditions and information on operations corresponding thereto may be stored in the storage unit of the automated guided vehicle (for example, in the recording unit 220), and the control unit in the automated guided vehicle may refer to the information in the storage unit to execute the various corresponding operations. Alternatively, as described below, the above control unit may receive signals automatically transmitted from the operation controlling device 4000 and the control device 3000 to execute operations based on the signals.

At least any of the operation controlling device 4000 and the control device 3000, receiving a notification from the automated guided vehicle, may automatically execute predetermined response operations. For example, when a notification of disconnection between the cart being conveyed and the automated guided vehicle, or a notification indicating a collision of the cart or the automated guided vehicle with an obstacle is received, at least one of the operation controlling device 4000 and the control device 3000 may send to the automated guided vehicle a signal instructing to make an emergency stop. In the storage unit of the operation controlling device 4000 and the control device 3000 are stored the contents of the received notification (disconnection, contact with an obstacle, for example) and the contents of the corresponding operations (emergency stop instruction, for example), being associated with each other, where the control unit refers to the storage unit to execute the corresponding operations.

The embodiment of the present disclosure has been described in detail with reference to the accompanying drawings; the technical scope of the present disclosure is not limited thereto. It is apparent that a person skilled in the art of the present disclosure can conceive various examples of changes or modifications within the scope of the technical idea described in the claims, and it is understood that these also naturally fall within the technical scope of the present disclosure.

The devices described herein may be realized as a single device or as plural devices (for example, cloud servers) connected to a network in part or in whole. For example, the control unit 260 and the recording unit 220 of the automated guided vehicle may be realized by different servers connected each other via a network. In the conveyance system described herein, the control device 3000, the operation controlling device 4000, and the I/O device 5000 are each composed of separate hardware connected via a network; however, some or all of the functions of the control device 3000, operation controlling device 4000, and I/O device 5000 may be implemented in the automated guided vehicle 10.

The series of processes by the devices described herein may be realized using software, hardware, and a combination thereof. Computer programs that realize each function of the control unit 260 according to the embodiment may be prepared to be installed on a PC or other device. Computer-readable recording media in which the above computer programs are stored can also be provided. The recording media are, for example, a magnetic disk, optical disk, magneto-optical disk, and flash memory. The above computer programs may also be delivered, for example, via a network, without using a recording media.

The processes described herein with reference to flowcharts do not necessarily need to advance in the order illustrated. Some steps may advance in parallel. Additional steps may be employed, while some steps may be omitted.

The effects described herein are only descriptive or exemplary and not restrictive. In other words, the technology of the present disclosure may produce other effects that are obvious to those skilled in the art from the description herein, either together with or in place of the above effects.

The following configurations also fall within the technical scope of the present disclosure.

### [Item 1]

A conveyance system comprising a conveyed object and an automated guided vehicle that conveys the conveyed object,
wherein the automated guided vehicle includes
   a connecting part that detachably connects to a connected part provided on the conveyed object,
   a pair of electrodes that energize through connection between the connecting part and the connected part,
   an energized state detecting unit that acquires information on an energized state of an electric circuit provided with the pair of electrodes, and
   a judging unit that judges a connection state between the automated guided vehicle and the conveyed object based on the information on the energized state.

### [Item 2]

The conveyance system according to item 1,
wherein the conveyed object includes a contact sensor that changes in the energized state through contact with an obstacle,
the contact sensor electrically connects to the pair of electrodes through the connection between the connecting part and the connected part,
the judging unit detects the contact with the obstacle based on information on the energized state with the connecting part and the connected part connecting to each other.

### [Item 3]

The conveyance system according to items 1 or 2,
wherein the connecting part has at least one rod member that advances and retracts axially toward the connected part that is concave.

### [Item 4]

The conveyance system according to items 1 or 2,
wherein the connecting part has at least two rod members that advance and retract axially toward the connected part that is concave, and
the at least two rod members are respectively provided with one and the other of the pair of electrodes.

### [Item 5]

The conveyance system according to any of items 1-4,
wherein the connected part is laid under the bottom surface of the conveyed object.

### [Item 6]

The conveyance system according to any of items 1-5,
wherein the connected part has a first connected part to which the connecting part connects on connection of the automated guided vehicle to the conveyed object in a first posture, and a second connected part to which the connecting part connects on connection of the automated guided vehicle to the conveyed object in a second posture different from the first posture.

### [Item 7]

The conveyance system according to any of items 1-6,
wherein the automated guided vehicle includes another connecting part that serves as an axis of rotation by rotating the automated guided vehicle with the connecting part connecting to the connected part on changing of a posture of the automated guided vehicle from a connection state to the conveyed object.

### [Item 8]

The conveyance system according to any of items 1-7,
wherein a notification on the connection state is made to an information processing device capable of communicating with the automated guided vehicle based on a result on the connection state judged by the judging unit.

### [Item 9]

The conveyance system according to item 2,
wherein a notification on contact with the obstacle is made to an information processing device capable of communicating with the automated guided vehicle on detection of the contact with the obstacle.

### [Item 10]

The conveyance system according to item 2,
wherein a notification having information on contact with an obstacle and information on the connection state is made to an information processing device capable of communicating with the automated guided vehicle on detection of the contact with the obstacle by the judging unit.

### [Item 11]

The conveyance system according to any of items 1-7,
wherein the automated guided vehicle implements a predetermined operation based on a result on the connection state judged by the judging unit.

### [Item 12]

The conveyance system according to item 2,
wherein the automated guided vehicle implements a predetermined operation on detection of a contact with the obstacle by the judging unit.

### [Item 13]

An automated guided vehicle conveying a conveyed object, comprising
a connecting part that detachably connects to a connected part provided on the conveyed object,
a pair of electrodes that energizes through connection between the connecting part and the connected part,
an energized state detecting unit that acquires information on an energized state of an electric circuit provided with the pair of electrodes, and
a judging unit that judges a connection state between the automated guided vehicle and the conveyed object based on the information on the energized state.

### REFERENCE SIGNS LIST

1 conveyance system, 10 automated guided vehicle, 11 connecting part, 20 cart (conveyed object), 21 connected part

1. A conveyance system comprising a conveyed object and an automated guided vehicle that conveys the conveyed object,
wherein the automated guided vehicle includes
a connecting part that detachably connects to a connected part provided on the conveyed object,
a pair of electrodes that energize through connection between the connecting part and the connected part,
an energized state detecting unit that acquires information on an energized state of an electric circuit provided with the pair of electrodes, and
a judging unit that judges a connection state between the automated guided vehicle and the conveyed object based on the information on the energized state.

2. The conveyance system according to claim 1,
wherein the conveyed object includes a contact sensor that changes in the energized state through contact with an obstacle,
the contact sensor electrically connects to the pair of electrodes through the connection between the connecting part and the connected part,
the judging unit detects the contact with the obstacle based on information on the energized state with the connecting part and the connected part connecting to each other.

3. The conveyance system according to claim 1,
wherein the connecting part has at least one rod member that advances and retracts axially toward the connected part that is concave.

4. The conveyance system according to claim 1,
wherein the connecting part has at least two rod members that advance and retract axially toward the connected part that is concave, and
the at least two rod members are respectively provided with one and the other of the pair of electrodes.

5. The conveyance system according to claim 1,
wherein the connected part is laid under the bottom surface of the conveyed object.

6. The conveyance system according to claim 1,
wherein the connected part has a first connected part to which the connecting part connects on connection of the automated guided vehicle to the conveyed object in a first posture, and a second connected part to which the connecting part connects on connection of the automated guided vehicle to the conveyed object in a second posture different from the first posture.

7. The conveyance system according to claim 1,
wherein the automated guided vehicle includes another connecting part that serves as an axis of rotation by rotating the automated guided vehicle with the connecting part connecting to the connected part on changing of a posture of the automated guided vehicle from a connection state to the conveyed object.

8. The conveyance system according to claim 1,
wherein a notification on the connection state is made to an information processing device capable of communicating with the automated guided vehicle based on a result on the connection state judged by the judging unit.

9. The conveyance system according to claim 2,
wherein a notification on contact with the obstacle is made to an information processing device capable of communicating with the automated guided vehicle on detection of the contact with the obstacle.

10. The conveyance system according to claim 2,
wherein a notification having information on contact with an obstacle and information on the connection state is made to an information processing device capable of communicating with the automated guided vehicle on detection of the contact with the obstacle by the judging unit.

11. The conveyance system according to claim 1,
wherein the automated guided vehicle implements a predetermined operation based on a result on the connection state judged by the judging unit.

12. The conveyance system according to claim 2,
wherein the automated guided vehicle implements a predetermined operation on detection of a contact with the obstacle by the judging unit.

13. An automated guided vehicle conveying a conveyed object, comprising
a connecting part that detachably connects to a connected part provided on the conveyed object,
a pair of electrodes that energizes through connection between the connecting part and the connected part,
an energized state detecting unit that acquires information on an energized state of an electric circuit provided with the pair of electrodes, and
a judging unit that judges a connection state between the automated guided vehicle and the conveyed object based on the information on the energized state.
